(19) United States
(12) Patent Application Publication
(10) Pub. No.: US 2016/0151733 A1
(43) Pub. Date: Jun. 2, 2016

(54) DETECTING A CLEANING PROCESS IN A PLANT HAVING FILTERS ARRANGED SPATIALLY OFFSET FROM ONE ANOTHER

(71) Applicant: PRIMETALS TECHNOLOGIES AUSTRIA GMBH, Linz (AT)

(72) Inventors: Paul FISCHER, Linz (AT); Franz HARTL, Linz (AT); Thomas KEUSCH, Linz (AT); Thomas KUEHAS, Luftenberg (AT); Martin LEHOFER, Plainsboro, NJ (US); Axel RIESE, Linz (AT); Andreas ROHRHOFER, Linz (AT); Michael WEINZINGER, Neuhofen a. d. Kerms (AT)

(21) Appl. No.: 14/905,221

(22) PCT Filed: Jul. 9, 2014
(86) PCT No.: PCT/EP2014/064678

§ 371 Date: Jan. 14, 2016

(30) Foreign Application Priority Data
Jul. 17, 2013 (EP) 13176818.6

(51) Int. Cl. B01D 46/00

(52) U.S. Cl. CPC B01D 46/0086; B01D 46/0068

(57) ABSTRACT

A method for detecting a cleaning process in a plant having filters (1, 31) arranged spatially offset from one another, wherein a first gas (21) having solid particles (20) is conducted in a first flow direction (10) filtered by a respective filter (1, 31). To clean the respective filter (1, 31), a second gas (22) is conducted through the filter (1, 31) opposite the first flow direction (10). Then listen to noise produced in the filtering or other physical phenomena to determine a condition of the filter including if it is being cleaned. To detect a cleaning process in a plant, a respective noise (12) is detected by acoustic sensors (2, 32, 2′, 32′, 42) arranged spatially offset from one another during the cleaning of the respective filter (1, 31). Further disclosed are a system for detecting a cleaning process in a plant having such filters, and such a plant.

### CROSS-REFERENCE TO RELATED APPLICATIONS

The present application is a 35 U.S.C. §§371 national phase conversion of PCT/EP2014/064678, filed Jul. 9, 2014, which claims priority of European Patent Application No. 13176818.6, filed Jul. 17, 2013, the contents of which are incorporated by reference herein. The PCT International Application was published in the German language.

### TECHNICAL FIELD

The invention relates to a method for detecting a cleaning process in a plant having filters arranged spatially offset from one another. A first gas containing solid particles can be fed in a first flow direction through the filter concerned to be filtered for cleaning the filter, a second gas can be fed through the filter in a direction of flow opposite to the first direction of flow. A system for detection of a cleaning process for a plant has filters which are arranged spatially offset from one another for filtering a first gas containing solid particles. A plant of such a nature is described.

Use can be made of a process and equipment of this type, for example, in the field of flue gas cleaning in metallurgical processes. Examples of this are LD furnaces, electric arc furnaces, sintering processes, etc., for which dry tube filters are usually used. These filters serve to separate out the dust.

Cleaning off these separation products is based on the principle of “jet-pulse cleaning”, in which intense compressed air surges are released cyclically from a compressed air reservoir. These compressed air surges briefly subject the filter tube to an overpressure. This causes the filter tubes to be distended, the direction of flow is reversed and the filter cake detached. In the filtering phase, a support cage gives the tube a suitable rigidity. After cleaning off of the filter tubes, the dust particles form a sediment in the dust collection chamber, and the material is transported away from there, generally via screw conveyors and rotary air locks.

Such a tube filter plant typically consists of numerous filter tubes, for example several thousand, and the cleaning of tubes is effected sequentially. Currently, flue gas cleaning is controlled on a cyclic basis. If it is not possible to successfully clean a particular filter tube, it will not be until the next cleaning cycle, that is, after the cleaning of all the other filter tubes, that a new attempt will be made to clean this filter tube. Meanwhile, the functionality of this filter tube is heavily restricted. In the extreme situation, the result can be a failure of the dust removal plant.

In order to achieve the highest possible efficiency of the filtration plant, all the filter tubes must be correctly cleaned off. Hence, the detection of malfunctions is accorded a high importance. Because of the large number of installed cleaning valves, such detection can only be realized at a high technical cost. The solutions available on the market have only very restricted acceptance because of high costs or functional security deficiencies.

Among known solutions, for example, a direct pressure measurement at the upstream compressed air reservoir, of which one is installed for each segment, is made. For this purpose, the history of the pressure, that is its rise and fall, is evaluated. By comparing it with a characteristic pressure history, in particular for a good status, a conclusion is reached about the functionality of the filter tube concerned. This variant requires separate pressure measurement, including its evaluation, for each compressed air reservoir and consequently results in high costs.

Another known method is flow monitoring at the cleaning valves, but this method can only monitor the flow rate in the valve concerned. However, the method does not provide a statement about the correct cleaning off of the filter tube concerned because it will not be possible to recognize, for example, a mechanical malfunction or the absence of the compressed air.

A final known method is also measurement of the compressed air flow, at the supply line to the valves. This method does provide a statement about the interaction between electrical and pneumatic functions, provided that the sensing system has a rapid response characteristic, high repeat accuracy and a large measurement range. This variant also requires a separate through-flow measurement for each compressed air reservoir, including the evaluation, and consequently results in high costs.

The jet-pulse cleaning method for cleaning off, as cited above, is known from the Wikipedia article “Schlauchfilter” [Tube filters], called up on 23.04.2013.

From EP0020949A1, a device is known for monitoring of the closing and opening functions of membrane valves, in particular of membrane valves which are connected downstream from a compressed air reservoir in the cleaning jet lines of dust extraction facilities, wherein each of the lines can be controlled by means of electromagnetic valves, wherein there is attached to the housing of the membrane valve or on the housing of the compressed air reservoir a pulse generator which receives vibrations or noises, and wherein the pulses which are emitted can be compared individually with programmed individual control signals for the electromagnetic valves.

### SUMMARY OF THE INVENTION

The underlying object of the invention is to be able to detect, in a cost-effective and reliable way, a cleaning process in a plant of the type described in the introduction.

This object is achieved by methods of the type cited in the introduction wherein acoustic sensors, for picking up air sounds, are arranged with a spatial offset from one another. They capture a relevant noise which arises during the cleaning of the filter concerned, wherein the cleaning of the filter concerned is detected by the capture of the noise concerned by means of at least two acoustic sensors.

This object is further achieved by a system of the nature cited above in that a first gas, containing particles of solid matter, is fed through the filter concerned in a first flow direction and is filtered by the filter concerned. For the purpose of cleaning the filter concerned, a second gas is fed through the filter concerned in a direction of flow opposite to the first direction of flow. The system has acoustic sensors for picking up air sounds. The sensors are arranged offset relative to one another. The sensors make it possible to capture a noise which arises during the cleaning for the filter concerned. A computer unit can detect the cleaning of the filter concerned by picking up relevant noise by means of at least two of the acoustic sensors.

Finally, this object is achieved by a plant of the nature cited in the introduction. The plant has a system of this type and filters which are arranged spatially offset from one another, through which the first gas can be fed and by means of which the first gas can be filtered. For the purpose of cleaning the filter concerned, a second gas can be fed through the filter concerned in a reverse direction of flow.

The proposed method is based, among other things, on the acoustic recognition of a noise, the so-called “cleaning bang”. This noise can be evoked, in particular, by the surge of compressed air released for the purpose of cleaning the filter concerned, for example, when a compressed air valve is opened in order to force the second gas through the filter concerned in the direction of flow opposite to the first direction of flow. When the valve is opened a noise arises, as an air sound, which is typical for the cleaning of the filter concerned and which is captured by the relevant sensor. Accordingly, the sensor concerned is designed to be able to capture as air sounds the noises which arise. In particular, for each of the acoustic sensors, an audio data stream is created which can be analyzed, for example, by the computing unit.

The filter concerned, which can for example be constructed as a tube filter, is distended by the compressed air impact. This distension breaks off, from the filter concerned, the particles of solid matter, or a layer of solid matter particles, which have/has accumulated during the operation of the filter. By this too, a characteristic noise may be produced, which can be captured by the sensor concerned.

As sensors, use can be made in particular or one or more sound transducers, for example microphones, which are positioned within the filter plant and hence can be cost-effectively obtained. In particular, some of the acoustic sensors and the filters will be accommodated in a housing of the plant, where the sensors are affixed in such a way that they can capture the noises which are to be expected.

The plant has filters which are arranged with a positional offset from one another, wherein the acoustic sensors are also arranged with a positional offset from one another. This means that any two of the filters, or any two of the acoustic sensors, as applicable, are arranged at a certain distance from each other. Here, the proposed system is designed such that the noises which arise during the cleaning of one of the filters can be captured by means of at least two of the acoustic sensors. The difference in the time concerned for the noise to travel from the place where it arises to the sensor concerned permits the cleaning of a filter concerned to be detected.

This arrangement permits a particularly reliable detection of the cleaning of the filter concerned, wherein it is possible in particular to recognize so-called “matrix errors”. Errors of this type arise in plants in which the filters are cleaned in a particular sequence one after another, for which purpose appropriate valves are, for example, actuated one after another. In particular, in order to save as far as possible on PLC outputs, all the valves in a filter building are actuated by means of a relay matrix i.e. some relays switch the plus pole of the valve and a few further ones switch the minus pole of the valve. If a relay fails, it is possible for the contacts in the relay to weld up, so that during a subsequent cleaning operation several relays clean up or the wrong valve is activated. “Matrix errors” are also possible in principle as a result of incorrect cabling, so that the wrong valve is actuated and hence the wrong filter is cleaned. However, this type of error can be recognized and eliminated during commissioning. In particular when there is a malfunction of an incorrectly actuated valve, one can reach the erroneous conclusion that a correctly cleaned filter has apparently not been cleaned, and a filter which has not been cleaned or has been wrongly cleaned has apparently been cleaned.

It is of particular advantage with the proposed method, the proposed system and the proposed plant, that a correct cleaning of the filter concerned can be recognized reliably and comparatively easily. This is because the recognition of correct cleaning is based solely on the capture, by the use of at least two acoustic sensors, of the noise arising during the cleaning of the filter concerned. In particular, it is not necessary for the recognition that the precise time point of the cleaning for the filter concerned or the actuation of the appropriate valve, as appropriate, is known in advance.

With one advantageous embodiment of the invention, the cleaning of the filter concerned is detected by a comparison of the time points at which the relevant noise arrives at each of at least two, and preferably three or more, of the acoustic sensors.

Because the acoustic sensors are arranged to be spatially offset from one another or separated from one another in space, a noise which arises during the cleaning of one of the filters normally takes different lengths of time to reach the location of the sensor concerned. As a result of the fact that at least two, preferably three or more, acoustic sensors are used to capture the noise concerned, it is possible reliably to conclude where the noise arose, by which means it is possible to detect a successful cleaning process for the filter concerned. In particular, at the site of origination of the noise there is in each case either a valve through which the second gas flows into the filter concerned, or the filter concerned.

Depending on the size of the plant or depending on the number of filters in the plant, as applicable, a larger or smaller number of acoustic sensors will be required in order to achieve particularly reliable results. The acoustic sensors will preferably be arranged in such a way that the paths followed between the site at which the relevant noise arises and the sensor concerned permit an unambiguous assignment of the housing concerned to the successful cleaning of the filter concerned. For example, if there is a symmetrical arrangement of the filters an asymmetrical arrangement of the sensors can prove to be advantageous.

In the case of a further advantageous embodiment of the invention, by comparing for at least two, preferably three or more, of the acoustic sensors the relevant time points for the arrival of the noise concerned, at least one difference interval, preferably two or more difference intervals, is/are determined, the difference interval which is determined being compared with a relevant stored difference interval.

If one of the filters is impacted by the second gas, this should result in a noise which can be captured by the acoustic sensors. For example, suppose three sensors capture the noise at time points tᵢ respectively, where i=1, 2, 3. From the three time points tᵢ it is thus possible to determine up to three difference intervals δ_{i,i′}=tᵢ−t_{i′}, namely δ_{1,2}, δ_{1,3} and δ_{2,3}. The time point tᵢ concerned can here be regarded as the relevant marker time point, which is for example deduced from the relevant above mentioned audio data stream.

The difference intervals determined are compared with corresponding difference intervals, preferably determined in advance and stored, from which it is ultimately possible to determine the site of origination of the noise concerned. Thus, in particular, there is stored for each valve or for each filter, as applicable, the difference interval which is to be expected for each combination of acoustic sensors as a result of the locational positioning of the valve or filter respectively in the plant. Here, the relevant marker time point, different in each channel because of the speed of sound and an appropriate positioning of the microphones, does however identify the same sound event.

Provision can be made, in particular, that the computing unit compares each difference interval which is determined with the relevant difference interval, determined in advance, with an alarm being output if the difference in absolute or relative terms between the appropriate difference intervals exceeds or falls below, as applicable, a defined range.

In determining the differential interval, a knowledge, in particular a prior knowledge, of the precise time point at which the noise concerned arose, is not necessary. In particular, the differential interval concerned is independent of the precise time point at which the noise concerned arose, which makes the proposed method less susceptible to error and very reliable.

In the case of one further advantageous embodiment of the invention, for the purpose of determining the relevant time point for the arrival of the noise concerned at the relevant acoustic sensor, the point in time of a maximum amplitude of the noise is determined.

The determination of the applicable time point of the maximum noise amplitude, or the relevant time point with the highest loudness for the acoustic sensor concerned, as applicable, permits a particularly consistent determination of the relevant time point for the arrival of the noise concerned or of the differential interval, as applicable. The accuracy and reliability of the detection is thereby further increased.

In the case of a further advantageous embodiment of the invention, the relevant noise which has been captured is analyzed by means of a Fourier transformation.

Using the Fourier transformation it is possible to produce a spectral analysis of the noise concerned which has been captured, which can be used to further increase the reliability of detection of the cleaning of the filter concerned. In particular, the differential interval concerned, which was explained above, can also be determined with the assistance of a Fourier transformation. In particular, the control unit will for this purpose search in the individual signals from the acoustic sensors or in the relevant audio data stream, as applicable, for similar sections wherein the time shift between the sections concerned is identified as the relevant differential interval.

With one further advantageous embodiment of the invention, a first message is created if the energy, within a prescribable first frequency range, of the noise concerned which has been captured exceeds or falls below a prescribable first value, as applicable.

The energy concerned is determined, in particular, by integration or summation, as applicable, of the energy for the noise concerned within the first frequency range, i.e. between a lower and an upper frequency, which can be prescribed. If the cumulative energy falls below or exceeds, as applicable, the first value, which can be prescribed, there may for example be a malfunction of the filter concerned or valve concerned, as applicable, so that the filter concerned is not correctly cleaned. The prescribable first value can here, for example, be determined by tests carried out beforehand, and stored, where the prescribable first value characterizes the noise which arises during a successful cleaning operation.

The first message which is created incorporates in particular a note about the excess or undershoot examined, as applicable, and is for example communicated to a computing unit or directly to an individual who is responsible for the operation of the plant.

In the case of one further advantageous embodiment of the invention, a second message is created if a ratio of the energy of the noise concerned, captured within a prescribable second frequency range, to the energy of the noise concerned captured outside the prescribable second frequency range, exceeds or falls below a prescribable second value, as applicable.

The energy concerned within the prescribable second frequency range or outside it, as applicable, can be determined, in particular, in that the energy of the noise concerned respectively within or outside the prescribable second frequency range is integrated or summed up, as applicable. In doing so, the ratio of the energy within the prescribable second frequency to the energy outside the prescribable second frequency range is set, with the second message being produced if the ratio determined exceeds or falls below, as applicable, a prescribable second value.

If the ratio which is formed exceeds or falls below, as applicable, the prescribable first value, there may for example be a malfunction of the filter concerned, so that the filter concerned is not correctly cleaned. The prescribable second value can here, for example, be determined by tests carried out beforehand, and stored, where the prescribable second value will preferably characterize the noise which arises during a successful cleaning process.

The second message created includes in particular a note of the examined overshoot or undershoot, as applicable, and is communicated, for example, to a computing unit or directly to a person who is responsible for the operation of the plant.

In the case of one further advantageous embodiment of the invention, the relevant noise which has been captured is filtered by means of a high-pass filter.

A high-pass filter is, in particular, an electronic filtering circuit, by means of which lower frequencies can be attenuated, by which means the reliability of the detection of a cleaning process can be increased.

Further, the relevant noise which has been captured can be fed via one or more amplifiers to an analog/digital (A/D) converter, with the high pass filter being connected, in particular, in circuit before the A/D converter. Finally, the A/D converter is able to provide to the computer unit the noise in digitalized form.

The digitalized noise can be evaluated by the computing unit using an evaluation algorithm. This evaluation algorithm can, for example, be based on the following principles:
comparison of the sound level with a reference value
comparison of the history over time of the sound level with a reference curve,
evaluation of characteristic frequencies, e.g. using a fast Fourier transform (FFT) and/or
evaluation of the history over time of the level and frequency by means of machine learning.

In the computing unit, several evaluation algorithms may even be used to evaluate a set of noises which have been captured. The overall result can be produced, for example, by a weighted ‘voting’ algorithm. Here, the individual evaluation algorithms are allocated different weightings, depending on their predictive ability.

Thus the advantages which the inventive method brings are, in particular, a reliable detection of the cleaning process concerned, wherein it is possible to achieve an increase in the cleaning performance of the filter concerned by its correct cleaning, together with a cost advantage from very cost-effective measurement equipment, such as for example the acoustic sensor concerned in the form of a microphone.

For the purpose of communicating any relevant sensor signal, the sensor concerned can be linked to the computing unit by means of an electrical link. Also conceivable is a wireless communication of the sensor signal, in particular an optical one.

In the case of one further advantageous embodiment of the invention a sound enclosure is provided, in which are arranged some of the acoustic sensors and in which can be arranged a relevant valve, by means of which the second gas can be fed through the filter concerned in a direction of flow opposite to the first flow direction.

The sound enclosure can, for example, be constructed as a type of box, which suppresses or reduces noise interference from outside. By the sound enclosure, the reliability of detection of the cleaning can be further increased, because interfering noises from outside the sound enclosure can be effectively kept away from the acoustic sensor concerned. At the same time, it is ensured that the acoustic sensor concerned can detect the noises caused by the relevant valve particularly well. It is thereby possible, in particular, reliably to capture by means of the acoustic sensor concerned the opening of the relevant valve for the purpose of cleaning the filter concerned.

In particular, further acoustic sensors can be provided outside the sound enclosure, which are thus screened off acoustically from the valve concerned, and can capture the noises from the filter concerned during the cleaning process. These further acoustic sensors can, for example, be arranged within a housing in the plant in which the filter concerned is accommodated. Here, the sound enclosure can be arranged within or outside the housing.

The present invention covers yet further aspects, such as for example that the computing unit, by means of a comparison of the sensor signal with the reference sensor signal, determines a status for the filter concerned and/or for the valve concerned.

For example, such a status for the filter concerned could be of the form that the filter concerned has burst or is seriously damaged, as applicable. This can be established by the fact that the compressed air surge does not lead to distension of the filter concerned, which takes a certain amount of time, but takes place comparatively quickly. It is also conceivable that the status determined is that the filter concerned can no longer be cleaned by the compressed air surge, for example because the particles of solid matter have become permanently fixed in the filter concerned. A further status which can be determined is the extent to which the filter is clogged with particles of solid matter, from which it can be concluded when the next cleaning of this filter is necessary.

In addition, or alternatively, it is possible to capture the status of the relevant valve which must be opened for the cleaning operation on the filter concerned. Such a status can, for example, be that the relevant valve is no longer opening fully or is defective, which can be stored as a reference sensor signal and thereby can later be recognized.

In particular, it is possible for the status respectively of the relevant filter or of the relevant valve to be determined by the computing unit, which locates the status respectively of the filter concerned or the valve concerned, for example on a predefined scale. As explained above, the scale can here include two or more statuses.

In order to be able to determine statuses of this type for the filter concerned or the valve concerned, as applicable, filters or valves respectively can be suitably prepared beforehand and subjected to the usual compressed air surge, wherein in turn the noise which then arises is captured by the relevant acoustic sensor and stored as a reference sensor signal for the noise characteristic of the status concerned.

It is later possible to access these reference sensor signals, which characterize various statuses of the filter concerned or of the valve concerned, as applicable, in order to determine the status of a plant which is to be monitored.

In accordance with a further aspect of the invention, the sensor signal and/or if necessary the status of the filter concerned is stored in a memory unit, wherein a trend in the sensor signal, and/or if necessary in the status of the filter concerned, is determined by using a history over time of the sensor signal and/or, if necessary, of the status of the filter concerned or of the valve concerned, as applicable.

The storage of the sensor signal, and/or if necessary the status respectively of the filter concerned or of the valve concerned, permits the relevant history over time to be stored in the memory unit, so that even at a later time these items of data can be accessed. This is necessary, in particular, for the determination of the trend, which is determined on the basis of the stored history over time. For this purpose, use can be made of current methods.

By the determination of the trend it is possible, for example, to estimate when the filter concerned or valve concerned, as appropriate, will need to be maintained of replaced, as applicable. By this means it is possible, in particular, to increase the availability of the plant, because any such manual intervention can be included, for example, with maintenance work carried out as part of a regular cycle. By this means, it is possible to avoid additional maintenance work or shutdowns of the plant, as applicable.

In particular, the computer unit can thus also, as applicable, store the history of the sensor signal or the status respectively of the filter concerned or the valve concerned, in order to be able to form a history over time. This can be used to recognize the wear on a component, and hence to issue a message even before a total failure. The status which is determined can then be communicated to one or more alarm systems, together with the unique identifier respectively of the filter concerned or valve concerned, optionally including the time point of the measurement. The alarm system can take the form of an automation system, such as for example a process visualization system, a process management system or a condition monitoring system. Optionally, further items of data will also be communicated to the alarm system, e.g. the sensor signal which has been received by the acoustic sensor or a graphical evaluation. The alarm system can then, as appropriate, inform the operator or the maintenance engineer of the plant about the message on a screen or via a human machine interface (HMI) or by e-mail, SMS or report on a mobile operating device, such as a smartphone or tablet computer.

In accordance with one further aspect of the invention, a message is created if the sensor signal is the same as a previously defined sensor signal and/or if appropriate if the status is the same as a previously defined status.

The previously defined sensor signal and/or if appropriate the previously defined status could for example be characteristic of the filter concerned having burst or the filter concerned or valve concerned, as applicable, is seriously damaged. This can be established by the fact that the compressed air surge does not lead to distension of the filter concerned, which takes a certain amount of time, but takes place comparatively quickly or is entirely missing. In particular, the previously defined quantity also can be characteristic of it being no longer possible to clean the filter concerned with the compressed air surge, for example because the particles of solid matter have become permanently fixed in the filter concerned. A valve which is no longer functioning can also be recognized in this way.

For example, the sensor signal generated by the acoustic sensor concerned can characterize a volume of the noise, so that the message is then produced in particular if the sensor signal or the volume, as applicable, corresponds respectively to the previously defined sensor signal or volume. In particular, the previously defined sensor signal or the previously defined status can also, as appropriate, be in the form of a reference band or “alarm threshold” which must be reached in order to generate the message. Equally, the previously defined sensor signal or previously defined status, as applicable, could also be defined in the reverse way: the previously defined sensor signal or previously defined status respectively is then present if the cleaning bang is missing or sounds different. As a consequence, for this situation the message would be produced if the cleaning bang is missing or sounds different.

In particular, the reference sensor signal stored in the computer unit can be in the form of the previously defined sensor signal.

In accordance with a further aspect of the invention, the message which is produced is then communicated to an IT system and/or operating staff of the plant. The IT system can here in particular be in the form of a condition monitoring system or the alarm system explained above, as appropriate, to which if necessary the status which has been determined can also be communicated together with the unique identifier of the filter concerned, or the valve concerned, as applicable, together as an option with the time point of the measurement at one or more alarm systems. Alternatively or additionally, the message can also be communicated to maintenance staff or to staff responsible for the system. Further actions can be triggered by the communication of the message, such as for example the maintenance or replacement of the filter concerned.

Alternatively or additionally, the message can also be generated if, within a time span which can be prescribed, the trend in the sensor signal, explained above, reaches the previously defined sensor signal, and/or if necessary the status of the filter concerned or of the valve concerned, as applicable, reaches the previously defined status. This can be calculated in advance, for example by means of interpolation on the basis of the trend which has been determined.

In general, the second gas can here be identical to the first gas, so that for the purpose of cleaning of the filter concerned the first gas is forced through the filter concerned in a direction of flow which is opposite relative to the direction of flow for the filtering process. The filter can here be constructed, for example, as a tubular filter.

In what follows, the invention is described and explained in more detail by reference to the exemplary embodiments illustrated in the figures. These show:

### BRIEF DESCRIPTION OF THE DRAWINGS

FIG. 1 a section of an exemplary embodiment of the system in accordance with the invention during a filtering process,

FIG. 2 the section of the exemplary embodiment of the system in accordance with the invention during a cleaning process,

FIG. 3 a first exemplary embodiment of the inventive plant,

FIG. 4 a second exemplary embodiment of the inventive plant,

FIG. 5 an example of a history over time of the signals from two acoustic sensors, and

FIG. 6 a schematic drawing of a third exemplary embodiment of the inventive plant.

### DESCRIPTION OF EMBODIMENTS

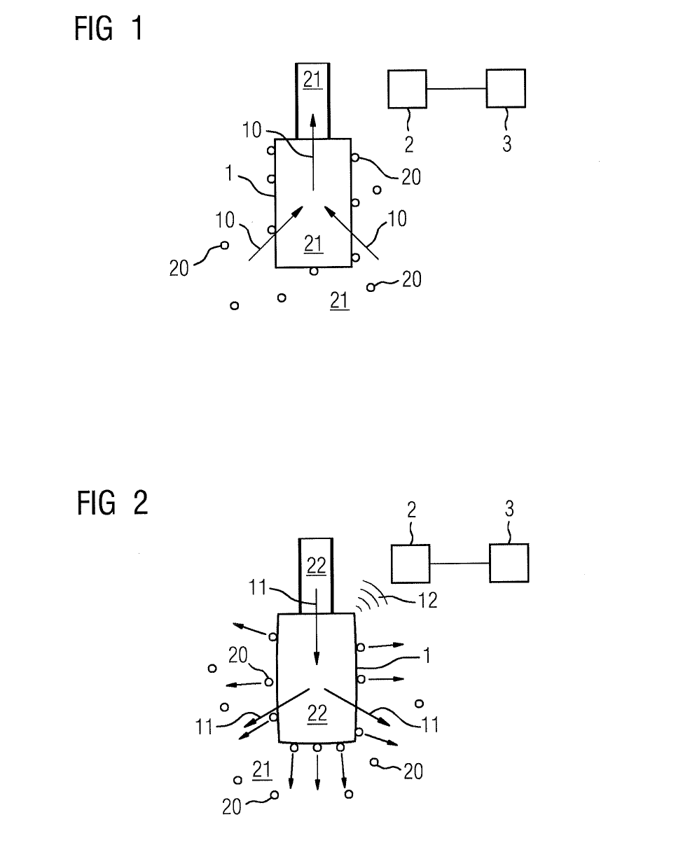

FIG. 1 shows a section of an exemplary embodiment of the inventive system during a filtering process. For the filtering process a first gas 21, which carries along with it particles of solid matter 20, is moved in a first direction of flow 10 through a filter 1. During this process, the particles of solid matter 20 are retained by the filter 1, so that when it leaves the filter 1 the first gas is cleaned of particles of solid matter 20.

The system has an acoustic sensor 2 for the purpose of capturing air sounds, and a computing unit 3 to which the sensor signals captured by the acoustic sensor 2 can be communicated. For the purpose of this communication, the acoustic sensor 2 and the computing unit 3 are connected to each other, for example via an electric, wireless or optical link.

FIG. 2 shows the section of the exemplary embodiment of the inventive system during a cleaning process. For the purpose of cleaning the filter 1, a second gas 22 is forced into and through the filter 1 in a direction of flow 11 opposite to the first direction of flow, wherein the particles of solid matter 20 which are adhering to the filter 1 are dislodged from the filter 1. This is achieved, for example, in that the filter 1 distends and a layer of particles of solid matter 20, which had formed on the surface of the filter 1, falls off.

During this cleaning process, a characteristic noise 12 arises, which is captured by the acoustic sensor 2.

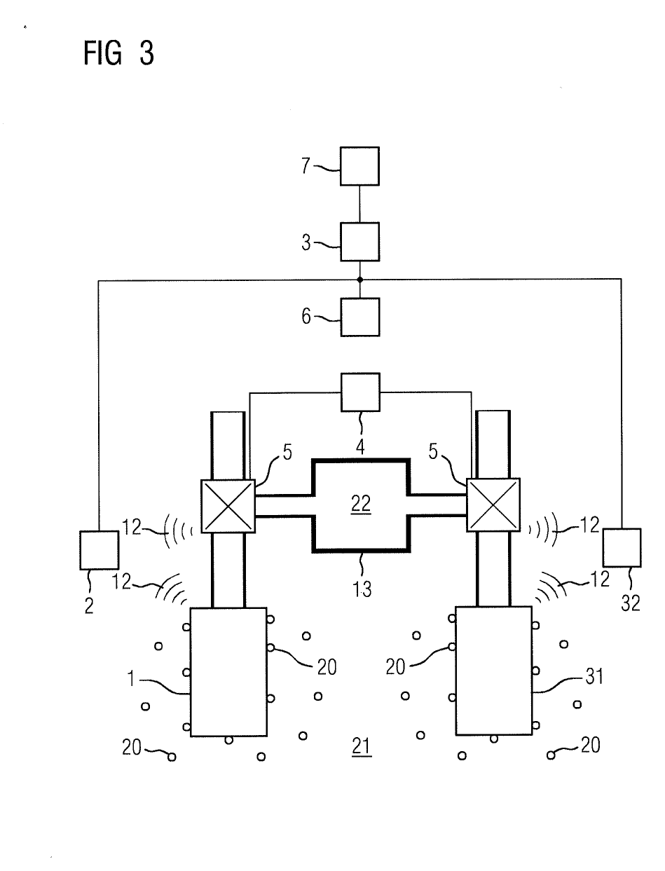

FIG. 3 shows a first exemplary embodiment of the inventive plant. The plant has filters 1, 31, in each case a valve 5 and a vessel 13. Here, the filter 1 or 31 respectively is used to filter particles of solid matter 20 which are present in a gas 21, as already shown and described in FIG. 1. In the vessel 13 there is a second gas 22 under a higher pressure. If the valve 5 concerned, which for the purpose of transmitting signals is linked to a control unit 4, receives an appropriate signal from the control unit 4, then the second gas 22 is forced out of the vessel 13, through the valve 5 concerned, into and through the filter 1 or 31 respectively. This causes particles of solid matter 20, which are adhering to the filter 1 or 31 respectively, to fall off the filter 1 or 31 respectively, thereby cleaning the filter 1 or 31 respectively.

During the cleaning process, a characteristic noise 12 arises, whether this be at the valve 5 concerned and/or at the filter 1 or 31 respectively, wherein the characteristic noise 12 is captured by two acoustic sensors 2, 32 which are arranged in positions offset from one another. The sensor signal can then be filtered by an electronic signal filtering unit 6, for example a bandpass filter or a high-pass filter and is finally communicated to a computing unit 3. The noise 12 concerned, which arises during the cleaning of the filter 1, 31, as applicable, is thereby captured by means of the two acoustic sensors 2, 32 which are used for the capture of air sounds. The cleaning of the filter concerned 1, 31 can finally be detected by the capture of the relevant noise 12 by means of the two acoustic sensors 2, 32.

The detection of the noise 12 concerned or of the cleaning of the filter 1, 31 concerned is based in particular on the different travel time in each case for the noise 12 from the location of its origination to the acoustic sensor 2, 32 concerned. To this end, the acoustic sensors 2, 32 will preferably be suitably arranged.

Hence, the cleaning operation concerned can be detected, and in particular malfunctions of the cleaning operation concerned can be ascertained. Furthermore, the computing unit 3 can be designed for the purpose of determining a status of the filter 1 or 31, as applicable, and/or of the valve 5 concerned.

Furthermore, the sensor signals, the status of the filter 1 and/or of the valve 5 can be stored in a memory unit 7, so that a determination can be made of a trend in the quantity concerned.

For the purpose of communicating signals or data, as applicable, the controller 4 is connected to both the valve 5 concerned and also with the acoustic sensor 2 or 32, wherein the relevant acoustic sensor 2 or 32 respectively is connected to the electronic signal filtering unit 6 and to the computing unit 3, which is finally connected to the memory unit 7. In this context, the connection concerned can be in wire-bound or wireless form, or can be optical, as applicable.

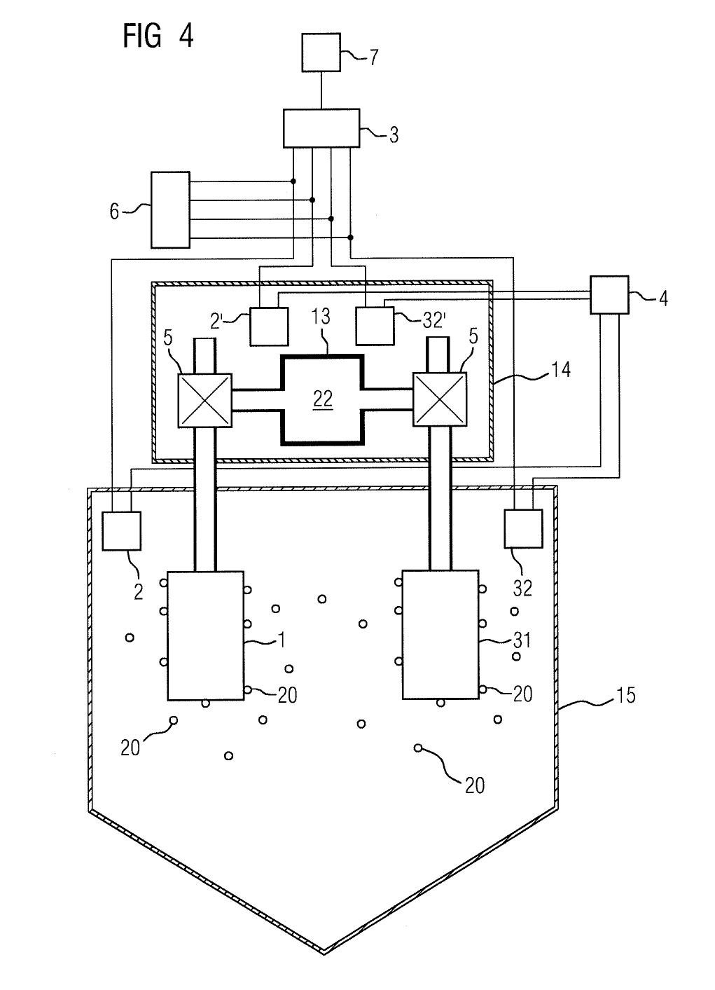

FIG. 4 shows a second exemplary embodiment of the inventive plant. As a departure from the first exemplary embodiment, the second exemplary embodiment of the inventive plant has a sound enclosure 14 and a housing 15. The housing 15 accommodates the two filters 1, 31 together with the two acoustic sensors 2, 32. In the sound enclosure 14 are the vessel 13 the valve 5 concerned together with two further acoustic sensors 2′, 32′ for capturing air sounds. The sound enclosure 14 is in this case arranged outside the housing 15.

The sound enclosure 14 screens off the acoustic sensors 2′, 32′ acoustically from noises from outside the sound enclosure 14, so that noises arising during the cleaning process due to the valve 5 concerned can be captured especially reliably by the acoustic sensors 2′, 32′. The acoustic sensors 2, 32 are, in particular, insulated acoustically from the valve 5 concerned. In addition, the acoustic sensors 2, 32 are acoustically insulated by the housing 15 from further interfering noises from outside the housing 15, so that they can reliably capture the noises from the relevant filter 1, 31 during its cleaning.

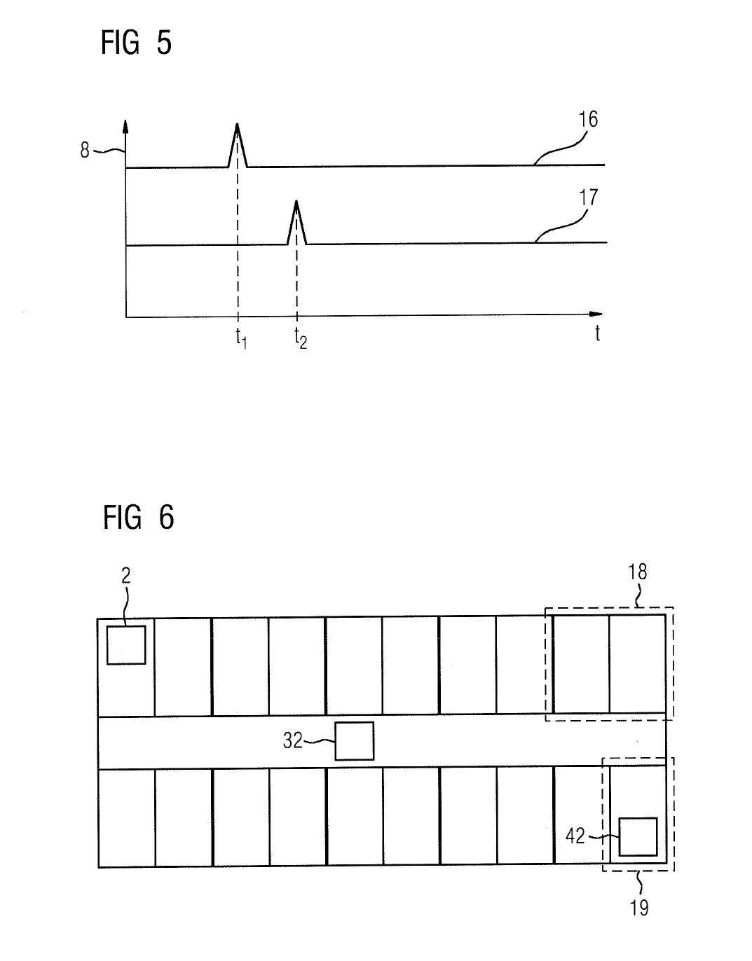

FIG. 5 shows an example of a history over time of the signals from two acoustic sensors for the capture of air sounds. Plotted on the abscissal axis is the time and on the ordinate axis the time-dependent amplitudes 8 of a first signal 16 and of a second signal 17. Here, the signals 16, 17 concerned originate from two acoustic sensors, in particular those of the exemplary embodiment of the inventive plant.

At a time point t₁ or t₂ respectively the first signal 16 or the second signal 17 has a peak value which, as applicable, indicates a noise amplitude or that the relevant assigned acoustic sensor has detected a noise. From the difference δt_{2,1}=t₂−t₁ it is possible to conclude the location at which the noise originated, wherein it is possible in particular to detect a cleaning process of one of the filters in the exemplary embodiment of the inventive plant.

FIG. 6 shows a schematic drawing of a third exemplary embodiment of the inventive plant. Accommodated in this plant are several acoustic sensors 2, 32, 42 for the capture of air sounds, where the plant has several compartments 18, each of which is made up of two chambers 19. Arranged in each of the chambers 19 there is in each case a filter, which can for example be constructed in the form as shown in FIG. 1.

A successful cleaning of one of the filters in the plant can be reliably detected by the acoustic sensors 2, 32, 42. Preferably, the acoustic sensors 2, 32, 42 will be suitably arranged for this purpose.

In summary, the invention relates to a method for the detection of a cleaning process in a plant having filters which are arranged with a spatial offset from each other, wherein a first gas containing particles of solid matter can be fed through the filter concerned in a first direction of flow and can be filtered by means of the filter concerned, wherein, for the purpose of cleaning the filter concerned, a second gas can be fed through the filter concerned in a direction of flow which is the opposite of the first direction of flow. Furthermore, the invention relates to a system for the detection of a cleaning process in a plant having filters, which are arranged with a spatial offset from each other, for the purpose of filtering a first gas containing particles of solid matter, and a plant of this type. In order to be able to cost-effectively and reliably detect a cleaning process in a plant of the type mentioned in the introduction, it is proposed that acoustic sensors, for the purpose of capturing air sounds, which are arranged in locations which are offset from one another, are used to capture a noise which arises during the cleaning of the filter concerned, wherein the cleaning of the filter concerned is detected by the capture of the noise concerned by reference to at least two of the acoustic sensors. Further, a system is proposed wherein a first gas, containing particles of solid matter, can be fed in a first direction of flow through the filter concerned and can be filtered by means of the filter concerned, wherein for the purpose of cleaning the filter concerned a second gas can be fed through the filter concerned in a direction of flow which is opposite to the first direction of flow, where the system has acoustic sensors, which are arranged with offset locations from one another, for capturing air sounds by means of which it is possible to capture a noise which arises during the cleaning of the filter concerned, and has a computing unit by means of which the cleaning of the filter concerned can be detected by the capture of the noise concerned by means of at least two of the acoustic sensors. Finally, a plant is proposed which has a system of this type and filters which are arranged with offset locations from one another, through which the first gas can be fed and by means of which the first gas can be filtered, wherein for the purpose of cleaning the filter concerned a second gas can be fed through the filter concerned in a direction of flow which is opposite to the first direction of flow.

1. A method for detecting a cleaning process in a plant having filters wherein the filters are arranged spatially offset from one another, the method comprising:
feeding a first gas containing solid particles in a first flow direction through the filters for the first gas;
for a purpose of cleaning the filters, feeding a second gas through the filters in a second direction of flow opposite to the first direction of flow,
capturing a relevant noise which arises during the cleaning of the filters by means of respective acoustic sensors for picking up air sounds for each of the filters, arranging respective sensors for each filter with a spatial offset from one another, wherein the cleaning of the filters is detected by the capture of the noise by means of at least two of the acoustic sensors,
by comparing, for at least two of the acoustic sensors for each of the filters, relevant time points for the arrival of the noise, and determining at least one difference interval, wherein the difference interval which is determined is compared with a relevant stored difference interval for the detecting of the cleaning process.

2. The method as claimed in claim 1, wherein the cleaning of each filter is detected by comparing the time points at which the relevant noise arrives at each of at least two acoustic sensors.

3. (canceled)

4. The method as claimed in claim 1, wherein, for determining the relevant time point for the arrival of the noise at the relevant acoustic sensor, determining a point in time of a maximum noise amplitude.

5. The method as claimed in claim 1, further comprising analyzing relevant noise which has been captured by means of a Fourier transformation.

6. The method as claimed in claim 5, further comprising:
creating a first message if, within a prescribable frequency range, the energy of the noise which has been captured exceeds or falls below a prescribable first value.

7. The method as claimed in claim 5, further comprising:
creating a second message if a ratio of the energy of the noise, captured within a prescribable second frequency range, to the energy of the noise captured outside the prescribable second frequency range, exceeds or falls below a prescribable second value, as applicable.

8. The method as claimed in claim 1, further comprising capturing the relevant noise and filtering the relevant noise by a high-pass filter.

9. The method as claimed in claim 1, further comprising providing a sound enclosure for at least two of the sensors for a filter, arranging the at least two acoustic sensors for the filter in the sound enclosure; and
providing a valve in the sound enclosure, arranging the valve, for feeding the second gas through the filter in a second direction of flow to the filter opposite to the first flow direction.

10. The method as claimed in claim 1, wherein the at least two acoustic sensors are configured to create a sensor signal,
communicating the sensor signal to a computing unit, and
determining by the computing unit, by comparing the sensor signal with a reference sensor signal, for determining a status for the at least one filter and/or for the valve for the at least one filter.

11. A system for the detection of a cleaning process in a plant having filters wherein the filters are arranged spatially offset from one another, the system comprising:
a first filter through which a first gas containing solid particles is fed in a first flow direction through the first filter to be filtered by the first filter, and a first device for feeding the first gas in the first flow direction;
a second device for feeding a second gas through the first filter in a direction of flow opposite to the first direction of flow for cleaning the first filter,
acoustic sensors configured for picking up air sounds, the acoustic sensors are arranged with a spatial offset from one another, the acoustic sensors are located and configured to capture a relevant noise which arises during the cleaning of the first filter; and
a computing unit configured to detect the cleaning of the filter by the capture of the noise by the at least two of the acoustic sensors; and
for the first filter, the computing unit being configured for comparing the at least two of the acoustic sensors for the first filter for relevant time points for the arrival of the noise, such that at least one difference interval is determined, wherein the difference interval which is determined is compared with a relevant stored difference interval.

12. The system as claimed in claim 11, further comprising:
a sound enclosure, in which the acoustic sensors for the first filter are arranged; and
the second device comprises a valve, configured and operable to feed the second gas through the first filter in a direction of flow opposite to the first flow direction.

13. A plant for filtering a first gas containing particles of solid matter, the plant comprising:
filters arranged spatially offset from one another, through which the first gas is fed and by which the first gas is filtered, the second device for feeding a second gas in a direction of flow through the filters for cleaning the filters, and
a system as claimed in claim 11.

14. The plant as claimed in claim 13 comprising:
the system further comprising a sound enclosure, in which the acoustic sensors for the filters are arranged; and
the second device comprises a valves arranged in the sound enclosure, configured and operable for feeding the second gas through the filters in a direction of flow opposite to the first flow direction of the first gas.

15. A system for the detection of a cleaning process in a plant having filters, wherein the filters are arranged spatially offset from one another, the system comprising:
a first filter through which a first gas containing solid particles is fed in a first flow direction through the first filter to be filtered by the first filter, and a first device for feeding the first gas in the first flow direction;
a second filter through which a second gas containing solid particles is fed in a second flow direction through the second filter to be filtered by the second filter, and a second device for feeding the second gas in the second flow direction;
devices for feeding a second gas through the first and second filters in directions of flow opposite to the first and second directions of flow for cleaning the first filters,
acoustic sensors configured for picking up air sounds, from the first and second filters, the acoustic sensors are arranged with a spatial offset from one another, first ones of the acoustic sensors are located and configured to capture a relevant noise which arises during the cleaning of the first filter, second ones of the acoustic sensors are located and configured to capture a relevant noise which arises during the cleaning of the second filter;
a computing unit configured to detect the cleaning of the first and second filters by the capture of the noises by the at least two of the acoustic sensors for each of the filters; and
for the first filter, the computing unit being configured for comparing the at least two of the acoustic sensors for the first filter for relevant time points for the arrival of the noise, such that at least one difference interval is determined, wherein the difference interval which is determined is compared with a relevant stored difference interval; and
for the second filter, the computing unit being configured for comparing the at least two of the acoustic sensors for the second filter for relevant time points for the arrival of the noise, such that at least one second difference interval is determined, wherein the second difference interval which is determined is compared with a relevant stored second difference interval.

16. The system as claimed in claim 15, further comprising:
a sound enclosure in which the acoustic sensors for the first and the second filters are arranged.
